(19) United States
(12) Patent Application Publication
(10) Pub. No.: US 2016/0164788 A1
(43) Pub. Date: Jun. 9, 2016

(54) Egress Rate Shaping To Reduce Burstiness In Application Data Delivery

(71) Applicant: QUALCOMM Incorporated, San Diego, CA (US)

(72) Inventors: Satashu Goel, San Diego, CA (US); Yinian Mao, San Diego, CA (US); Jay Kumar Sundararajan, San Diego, CA (US); Fatih Ulupinar, San Diego, CA (US); Michael George Luby, Berkeley, CA (US)

(21) Appl. No.: 14/663,528

(22) Filed: Mar. 20, 2015

Related U.S. Application Data
(60) Provisional application No. 62/087,932, filed on Dec. 5, 2014.

(51) Int. Cl. H04L 12/815; H04L 12/911; H04L 12/835; H04L 12/26

(52) U.S. Cl. CPC H04L 47/22; H04L 43/0876; H04L 47/823; H04L 47/30

(57) ABSTRACT

Systems, methods, and devices of the various embodiments enable rate shaping of content data delivered to a client application. A processor may determine an ingress rate of content data to a buffer. The processor may determine an amount of the content data stored in the buffer. The processor may determine an egress rate of the content data from the buffer to the client application based on the ingress rate and the amount of content data stored in the buffer. The processor may send the content data from the buffer to the client application at the egress rate.

### RELATED APPLICATIONS

This application claims the benefit of priority to U.S. Provisional Patent Application No. 62/087,932 entitled “Egress Rate Shaping To Reduce Burstiness In Application Data Delivery” filed Dec. 5, 2014, the entire contents of which are hereby incorporated by reference.

### BACKGROUND

Increasingly, data is delivered to devices over a data network. Content files, such as media content, may be streamed from a server to a client application such that a portion of the content may be received by the client application and presented to a user before all of the content data is received by the client. A transport accelerator may be used to increase the rate at which content data is delivered to the client. The transport accelerator may receive the content data over multiple streams (e.g., transport control protocol (TCP) connections) from the server. The transport accelerator may buffer (i.e., temporarily store in memory) data, and then deliver a portion of received data to an application for decoding and presentation.

When multiple parallel streams are used to download content, data that is received out of order may be buffered until all the gaps in the data are filled. This may result in bursty delivery of the content data to a client application, especially when the packet error rate is relatively high. Bursty data delivery to a client application may result in a lower-resolution presentation of the content. For example, when the burstiness of data delivery is severe, the client application may incorrectly estimate channel characteristics, such as by measuring a smaller stable data rate (i.e., smaller stable bandwidth) if the variation in an observed data rate is high. When the client application measures a smaller stable data rate, the client application may select a lower resolution at which to present the content, even though the content data is actually being received at a rate sufficient to present the content at a higher resolution.

### SUMMARY

Various embodiments include methods, and computing devices configured to implement the methods, for rate shaping data delivery to a client application, including determining an ingress rate of content data to a buffer, determining an amount of the content data stored in the buffer, determining an egress rate of the content data from the buffer to the client application based on the ingress rate and the amount of the content data stored in the buffer, and sending the content data from the buffer to the client application at the determined egress rate. In some embodiments the methods may further include determining an amount of deliverable content data in the buffer, and determining the egress rate of the content data from the buffer to the client application based on the ingress rate, the amount of the content data stored in the buffer, and the amount of deliverable content data in the buffer.

In some embodiments the methods may further include determining a time bound for delivery of the content data stored in the buffer to the client application, and determining the egress rate of the content data from the buffer to the client application based on the ingress rate, the amount of the content data stored in the buffer, and the determined time bound.

In some embodiments the methods may further include determining current communication link conditions of a communication link over which the buffer receives the content data, and determining the egress rate of the content data from the buffer to the client application based on the ingress rate, the amount of the content data stored in the buffer, and the current communication link conditions. In some embodiments the methods may further include predicting future communication link conditions of a communication link over which the buffer receives the content data, and determining the egress rate of the content data from the buffer to the client application based on the ingress rate, the amount of the content data stored in the buffer, and the predicted future communication link conditions.

In some embodiments the methods may further include determining a playback bit rate for presentation of the content data by the client application, and determining the egress rate of the content data from the buffer to the client application based on the ingress rate, the amount of the content data stored in the buffer, and the playback bit rate.

In some embodiments the methods may further include determining an egress rate variance limit for the buffer, and determining the egress rate of the content data from the buffer to the client application based on the ingress rate, the amount of the content data stored in the buffer, and the determined egress rate variance limit. In some embodiments the methods may further include determining a historical ingress rate of content data into the buffer, and determining the egress rate of the content data from the buffer to the client application based on the ingress rate, the amount of the content data stored in the buffer, and the historical ingress rate of content data into the buffer.

In some embodiments the methods may further include determining a historical amount of data in the buffer, and determining the egress rate of the content data from the buffer to the client application based on the ingress rate, the amount of the content data stored in the buffer, and the historical amount of data in the buffer. In some embodiments the methods may further include determining a historical communication link conditions of a communication link over which the buffer receives the content data, and determining the egress rate of the content data from the buffer to the client application based on the ingress rate, the amount of the content data stored in the buffer, and the historical communication link conditions.

In some embodiments the methods may further include determining whether an amount of the content data in a buffer of the client application meets a buffer threshold, and determining the egress rate of the content data from the buffer to the client application based on the ingress rate, the amount of the content data stored in the buffer, and whether the amount of content data in the buffer of the client application meets the buffer threshold. In some embodiments the methods may further include determining a difference between the amount of content data in the buffer of the client application and the buffer threshold, and determining the egress rate of the content data from the buffer to the client application based on the ingress rate, the amount of the content data stored in the buffer, and the difference between the amount of content data in the buffer of the client application and the buffer threshold.

In some embodiments, determining an egress rate of the content data from the buffer to the client application may include determining a variation of the ingress rate of the content data, and shaping the egress rate based on the determined variation of the ingress rate. In some embodiments, determining an egress rate of the content data from the buffer to the client application may include determining characteristics of an input channel of the content data to the buffer, and shaping the egress rate based on the determined characteristic of the input channel. In some embodiments, determining an egress rate of the content data from the buffer to the client application may include determining a behavior of the client application, and shaping the egress rate based on the determined behavior of the client application.

In some embodiments the methods may further include determining a preference of the client application for enabling rate shaping, and enabling egress rate shaping based on the determined preference of the client application. In such embodiments, determining a preference of the client application for enabling rate shaping may include determining the preference based on a request from the client application for the content data.

### BRIEF DESCRIPTION OF THE DRAWINGS

The accompanying drawings, which are incorporated herein and constitute part of this specification, illustrate exemplary embodiments of the various embodiments, and together with the general description given above and the detailed description given below, serve to explain the features of the various embodiments.

FIG. 1 is a block diagram of a communication system suitable for use with the various embodiments.

FIG. 2A is a block diagram of a communication system suitable for use with the various embodiments.

FIGS. 2B-2H are a series of rate-over-time graphs illustrating exemplary impacts of egress rate shaping according to various embodiments.

FIG. 3 is a process flow diagram illustrating a method for rate shaping data delivery to a client application according to various embodiments.

FIG. 4 is a process flow diagram illustrating another method for rate shaping data delivery to a client application according to various embodiments.

FIG. 5 is a process flow diagram illustrating another method for rate shaping data delivery to a client application according to various embodiments.

FIG. 6 is a process flow diagram illustrating another method for rate shaping data delivery to a client application according to various embodiments.

FIG. 7 is a component block diagram of a mobile communication device suitable for implementing various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the various embodiments or the claims.

The various embodiments provide methods, and devices configured to implement the methods, that enable rate shaping of data delivery to a client application. The various embodiments may be particularly useful for use in rate shaping data from a transport accelerator or rate shaper, which may receive and buffer content data before delivering the content data to the client application.

As used herein, the term “wireless device”, “communication device” and “mobile communication device” are used interchangeably herein to refer to any one or all of cellular telephones, smartphones, personal or mobile multi-media players, personal data assistants (PDAs), laptop computers, tablet computers, smartbooks, palmtop computers, wireless electronic mail receivers, multimedia Internet enabled cellular telephones, wireless gaming controllers, personal computers, television set top boxes, televisions, cable television receivers, and similar personal electronic devices which include a programmable processor, memory and circuitry for presenting media content.

The term “server” is used to refer to any computing device capable of functioning as a server, such as a web server, an application server, a content server, a multimedia server, or any other type of server. A server may be a dedicated computing device or a computing device including a server module (e.g., running an application which may cause the computing device to operate as a server).

The terms “component,” “module,” “system,” and the like as used herein are intended to include a computer-related entity, such as, but not limited to, hardware, firmware, software, a combination of hardware and software, or software in execution, that is configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

To increase a rate of delivery of content data to a client application, a transport accelerator may receive the content data over multiple data transport streams (e.g., transport control protocol (TCP) connections) carried by a network (e.g., the Internet) from a server or multiple servers. The transport accelerator may buffer the content data as it is received (i.e., temporarily store the data in memory), and then deliver a portion of the received data to an application (referred to herein as a “client application”), such as a media player, for decoding and presentation. In some embodiments, the transport accelerator and the client application may be co-located, such as separate modules or applications executing within a wireless device. In some embodiments, the transport accelerator may be located at a base station or access point, while the client application executes on a communication device (e.g., a smartphone, television, personal computer, etc.)

When a transport accelerator uses multiple parallel streams to download content, the transport accelerator may buffer data that is received out of order until all the gaps in the data sequence are filled, at which point the transport accelerator may send completed sequences of data to the client application for decoding and rendering. As mentioned above, this process may result in bursty delivery of the content data (i.e., delivery of data at a highly variable data rate) to the client application, especially when the error rate of packets received by the transport accelerator is relatively high. Bursty data delivery may also result from high-speed data networks, such as 4G, 5G, and other future network systems. For example, some transport protocols or network technologies may provide certain designated opportunities to transmit data to a receiving device; in effect, the protocol or network itself may cause bursty data delivery.

Bursty data delivery to a client application may degrade the operation of the client application in various ways. For example, bursty data delivery to a client application may result in a lower-resolution presentation of the content. When the burstiness of data delivery is severe (i.e., when the variation in an observed data rate is high), the client application may incorrectly estimate channel characteristics of a communication link between the wireless device and the source of data (e.g., a transport module or a base station or access point) as the lower stable data rate. In effect the client application may determine that the source of content data has a smaller stable bandwidth than is in fact the case. When the client application determines that the source of content data has a low stable data rate, the client application may select a lower resolution at which to present the content than is necessary given the actual data reception rate experienced by the transport accelerator. Thus, if the transport accelerator pushes data to the client application in bursts due to the way data is received and buffered, the resulting user experience may be impacted by the client application unnecessarily reducing the resolution of the content presentation.

Additionally or alternatively, the client application receiving bursty data delivery may make an incorrect decision about when to begin presentation of media (e.g., when to begin playback of video and performance), may make inappropriate rendering or playback rate of received media (e.g., the client application is performing adaptive streaming), or may make an incorrect decision about whether to stall media rendering or playback.

To address the potential impact on the user experience from bursty data delivery to client applications, the systems, methods, and devices of the various embodiments enable rate shaping of content data delivery to the client application. In some embodiments, the rate at which data received from a network is delivered to a client application may be controlled or shaped by a rate shaper module that may temporarily buffer data for the purpose of rate shaping. In some embodiments, rate shaping of content delivered from a buffer to a client application may be implemented within a transport accelerator that receives data from a network and temporarily stores the data in a buffer in order to place received data packets/chunks in a proper sequence. For conciseness, the term “rate shaper” as used herein may refer to both a rate shaper and a transport accelerator implementing the various embodiments, and the various embodiments are not limited to either a rate shaper nor to a transport accelerator. Also for conciseness, the rate at which content data is delivered from the buffer to client application may be referred to as the “egress rate,” while the rate at which the rate shaper stores content data in the buffer may be referred to as the “ingress rate.”

Performing rate shaping on data delivered to a client application to smooth out burstiness may provide a variety benefits. For example, rate shaping may prevent a client application from incorrectly determining that the source of content data may provide a lower stable data rate than the content source may otherwise provide, and enable the client application to select an appropriate resolution at which to present the content. In addition, performing rate shaping on data delivered to the client application may enable the client application to make a more accurate decision about when to begin presentation of media, or to select an appropriate rendering or playback rate of received media. Further, rate shaping may enable the client application to make a correct decision about whether to stall media rendering or playback, and may also enable the client application to provide correct information about a delivery time of a large file download. Performing rate shaping on data delivered to a client application may enable applications that have been written and/or designed for lower speed communication networks to be used in newer, higher speed networks (e.g., 5G networks and beyond) without being rewritten for use in newer networks.

Bursty data delivery may also occur due to variations in the data rate on a communication link. For example, a communication link data rate may vary over time because the signal strength received at a mobile device is time varying. In another example, millimeter wave frequencies may be used for communication, so that a data rate provided by a communication link may be strongly dependent on a line-of-sight path between a transmitter and the receiving device. Thus, the data rate achieved over the communication link may fluctuate significantly due to changes in the environment. Further, some communication technologies may provide a high rate but with a highly variable latency. For example, the medium access protocol may allow transmission in only some time-periods. In all of these cases, the wireless device may receive data at a highly variable (i.e., bursty) rate.

In addition, rate shaping may smooth out burstiness introduced by limitations of the rate shaper itself. Another cause of bursty data delivery to the client application may be that the rate shaper is only allowed to deliver data during certain time periods. For example, a user may pause media playback. As another example, the client application may go into a “pacing” mode in which the client application continues media playback but stops downloading further content because it has buffered a sufficient amount of data. In both cases, the client application may stop receiving data from the rate shaper. When the client application is ready to receive more data at a later time, a large amount of data may be available at the rate shaper. The delivery of a large amount of buffered data in a short period of time may result in bursty data delivery to the client application.

In the various embodiments, the rate shaper may perform rate shaping on data that is received and temporarily stored (i.e., buffered) in a memory of the rate shaper in order to smooth the delivery of the content data to the client application. In some embodiments, the rate shaper may dynamically determine an egress rate at which the rate shaper may send content data to the client application. The rate shaper may determine the egress rate based on certain conditions observed by the rate shaper, such as an ingress rate of content data, the size of the buffer in the rate shaper, and a number of deliverable bytes buffered in the rate shaper (e.g., a sequence of content data packets that are in order or substantially in order). The rate shaper may also determine the egress rate based on certain conditions detectable by the wireless device, such as current and future conditions of a communication link over which the wireless device receives the content data, and a determined or desired playback rate at which the client application may present the content data. The rate shaper may also determine the egress rate based on certain egress rate variance limits, historical ingress rate, a historical amount of data in the buffer of the rate shaper, historical communication link conditions, and an amount of data in a client application buffer.

In some embodiments, the rate shaper may shape traffic to map the shape of egress traffic (i.e., data sent to the client application) to a shape of the ingress data received from the network, such as a variation in the ingress rate over time. The description of the shape may be in the form of a statistical measure. For example, a processor may determine an average or median ingress rate. A processor may also determine a statistical measure or statistical analysis of the ingress rate, such as a percentile of the distribution of data rate, or statistics of inter-arrival times of content data received from the communication network. In some embodiments, the shape of the ingress data may be described using a probabilistic description, such as the joint probability distribution of a number of received bytes and/or inter-arrival times. Additionally or alternatively, in some embodiments, the rate shaper may shape traffic to map the characteristics of egress traffic to the characteristics of the channel between the rate shaper and a server sending the data (i.e., an input channel over which the communication device receives the content data). Some examples of channel characteristics include a round trip time (RTT), a packet error rate (PER), a probability of PER, a joint probability distribution of number of bytes and inter-arrival times, and combinations of any of such metrics.

In some embodiments, the rate shaper may shape the egress rate based on the shape of the ingress rate and/or the characteristics of the input channel in order to provide the content data to the client application in a way that reflects variations in the ingress rate and/or characteristics of a channel over which the content data is received. The client application may thus select a playback rate appropriately supported by the channel, and may request subsequent content data at an appropriate playback rate. In some embodiments, the characteristics of the channel may be measured by a network-monitoring module of the communication device.

In some embodiments, the rate shaper may shape the egress rate according to a description provided to the rate shaper. The source of this description may be the communication network or a user input. The description may be in the form of a statistical measure or a probabilistic description. For example, a network operator desiring to restrict a rate of adaptive video playback by the client application may impose an upper limit on an egress rate so that the client application does not select a relatively high playback rate (e.g., a playback rate above a limit or threshold), which may not be adequately supported by the network operator or a content provider. This network-imposed restriction may be based, for example, on a subscription or subscription level associated with the communication device, a time of day, network congestion, or a name or type of client application. In some embodiments, the description may be determined by the rate shaper based on the application, a radio access technology (RAT) of a wireless communication link, a subscription plan associated with the communication device, a battery level of the communication device, or combinations of such factors. For example, when a battery level of the communication device is low, the rate shaper may select a lower egress rate so that the client application chooses a lower rate for video playback. This may reduce the power of the communication device needed to download, decode, and render the content.

In some embodiments, rate shaping may be especially helpful for video streaming applications in which the client application may choose a bitrate for playback based on observed channel characteristics (e.g., as may be performed by an adaptive rate player or similar client application). The various embodiments may enable a rate shaper to apply rate shaping to content data control the egress rate of the content data to a streaming media client application, such as a Dynamic Adaptive Streaming over HTTP (DASH) client. In some embodiments, controlling the egress rate of the content data may include applying rate shaping to the content data prior to sending the content data, applying rate shaping while sending the content data, or applying rate shaping after receiving or executing a command to send the content data to the streaming media client application. Sending rate-shaped content data to the client application may improve presentation of the content data, for example, by enabling the client application to select a higher playback resolution than it might otherwise select when rate shaping is not applied to the content data.

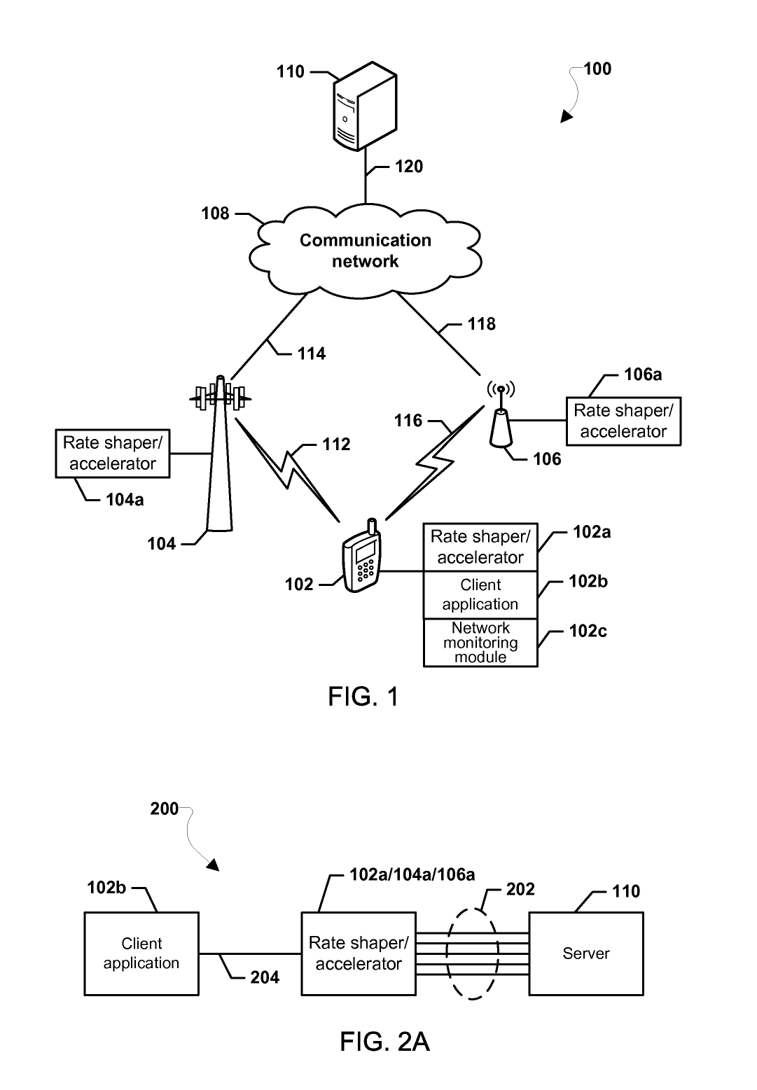

Various embodiments may be implemented in a variety of computing devices that receive content data over a network (e.g., the Internet), such as wireless devices that may operate within a wireless communication system 100, particularly a wireless communication system that includes at least two communication networks, an example of which is illustrated in FIG. 1.

Referring to FIG. 1, a wireless device 102 may communicate with a communication network 108 that may include a base station 104, an access point 106, and a server 110. The base station 104 may communicate with the communication network 108 over a wired or wireless communication link 114, and the access point 106 may communicate with the communication network 108 over a wired or wireless communication link 118. The communication links 114 and 118 may include fiber optic backhaul links, microwave backhaul links, and other communication links. In some embodiments, the communication network 108 may include a mobile telephony communication network. The wireless device 102 may communicate with the base station 104 over a wireless communication link 112, and with the access point 106 over a wireless communication link 116. The server 110 may be an application server, a content server, a media server, or another network node or network element configured to provide content data for a client application 102b, e.g., on the wireless device 102. The server 110 may communicate with communication network over a wired or wireless communication link 120. The wireless device 102 may send requests for content data, such as multimedia content, to the server 110 over the communication network 108, requesting delivery of the content data to the client application 102b. In response, the server 110 may stream the requested content data to the wireless device 102 over one or more wired or wireless communication links 120. In some embodiments, the wireless device 102 may receive the requested content data over a single interface (e.g., over a cellular communication interface, or over a Wi-Fi communication interface). In some embodiments, the wireless device 102 may receive the content data over multiple interfaces (e.g., over Wi-Fi and cellular communication interfaces), and the wireless device 102 may receive multiple parallel streams over the multiple network interfaces.

In some embodiments, the wireless device 102 may also include a network monitoring module 102c that may be configured to measure characteristics of the communication channel. For example, the wireless device may use the network monitoring module to determine channel characteristics, such as RTT, PER, a probability of PER, a joint probability distribution of number of bytes and inter-arrival times, and combinations thereof. The wireless device may also determine other channel characteristics, including a maximum data rate or throughput of received content data, an average or stable data rate or throughput of received content data, a signal strength measurement (e.g., a reference signal received power (RSRP) or received signal strength indicator (RSSI)), a signal quality measurement (e.g., a reference signal received quality (RSRQ) or channel quality indicator (CQI)), an amount of channel or communication link congestion, and any other metrics, including combinations of such metrics.

The communication network 108 may support communications using one or more radio access technologies, and each of the wireless communication links 112 and 116 may include cellular connections that may be made through two-way wireless communication links using one or more radio access technologies. Examples of radio access technologies may include LTE, Worldwide Interoperability for Microwave Access (WiMAX), Code Division Multiple Access (CDMA), Time Division Multiple Access (TDMA), Wideband CDMA (WCDMA), GSM, a radio access protocol in the IEEE 802.11 family of protocols (e.g., Wi-Fi), and other radio access technologies. While the communication links 112 and 116 are illustrated as single links, each of the communication links may include a plurality of frequencies or frequency bands, each of which may include a plurality of logical channels.

Multimedia streaming may include requirements, such as the delivery of data at a relatively steady rate and with a relatively low latency, that conventional network protocols, such as transport control protocol (TCP) and hypertext transfer protocol (HTTP), may be poorly designed to meet. Multimedia streaming may also be inefficient under congested network conditions due to packet loss and/or large round trip times. Mobile communication networks may be more susceptible to such challenges than wired communication systems.

To address these issues, a rate shaper may be employed to improve the receipt of content data and its delivery to the client application. A rate shaper may receive requested content data over multiple network connections in parallel to increase the speed of content delivery to the client application. In the various embodiments the rate shaper may apply rate shaping to smooth the delivery of content data to the client application. A rate shaper may be located in the wireless device (e.g., within a rate shaper/accelerator 102a), in a base station (e.g., a rate shaper/transport accelerator 104a), or in an access point (e.g., a rate shaper/transport accelerator 106a).

While a transport accelerator may be used in some embodiments, in some embodiments a rate shaper may receive a single stream of content data from the server and control the rate at which the data is passed to a client application. In such embodiments, the rate shaper may apply a rate shaping function to the content data received over the single stream in order to modulate any burstiness in the data stream, which could be caused by data loss (e.g., packet loss), congestion in the communication network, time-varying signal strength or limited transmission opportunities due to the medium access protocol. Thus, a rate shaper may apply rate shaping to smooth the delivery of content data to a client application.

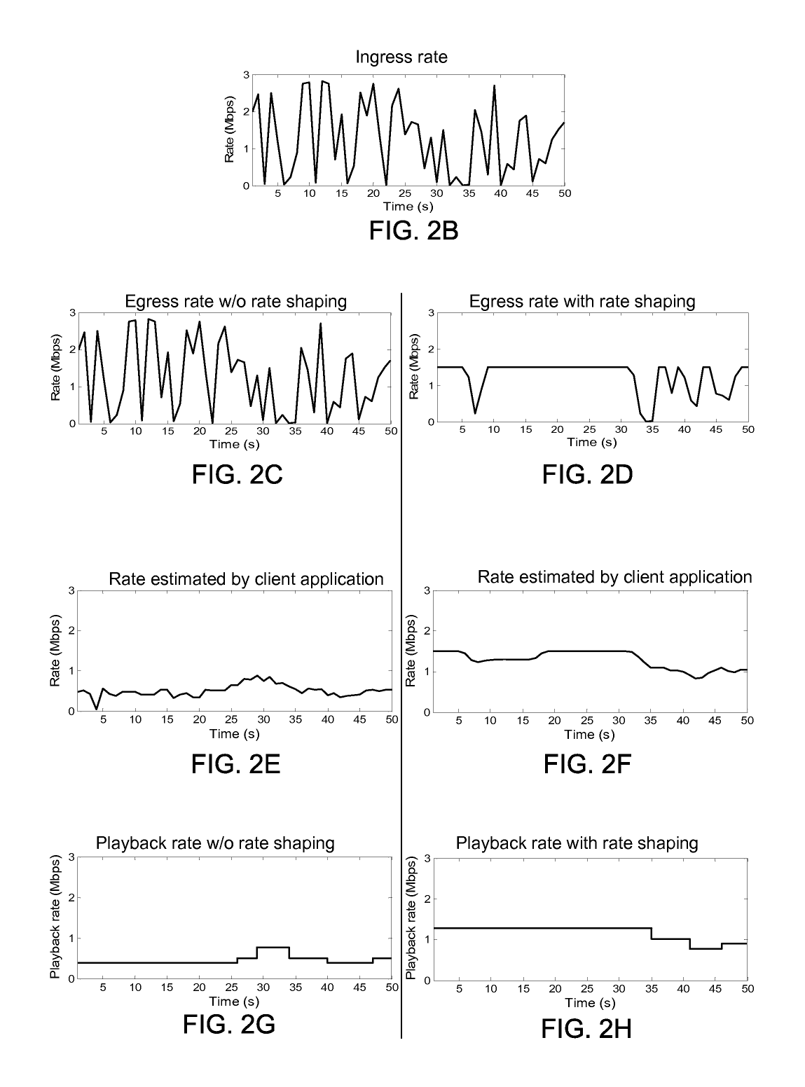

FIG. 2A illustrates a communication system 200 suitable for use with the various embodiments. To increase a rate at which content data is delivered to the client application 102b, a rate shaper (e.g., the rate shaper/accelerator 102a, 104a, or 106a) may receive the content data over multiple streams 202 (e.g., multiple TCP connections, or multiple HTTP connections) from the server 110. Received content data may be buffered in a memory of the rate shaper and delivered to the client application over a communication link 204.

When multiple parallel streams are used to download content, data that is received out of order (e.g., packet reordering or packets received out of sequence) may be buffered in the rate shaper until each of the data packets in a particular sequence are received, at which point the received data packet sequence may be delivered to the client application. As the amount of packet reordering increases, delay in delivery of some content data packets to the client application may also increase, and the burstiness of content data delivered to the client application may increase. As noted above, the various embodiments provide methods for rate shaping content data delivered to a client application to avoid the impacts on user experience that may occur if the client application adjusts its presentation resolution to match a measured stable data rate that is less than the actual overall rate at which content data is being received.

FIGS. 2C-2H illustrate the impact of delivering bursty data illustrated in FIG. 2B to a client application and certain improvements in performance of a client application resulting from egress rate shaping according to various embodiments. A client application (e.g., the client application 102b of FIGS. 1 and 2A) may be an adaptive video player. As illustrated in FIG. 2B an ingress rate of data may be highly variable. When egress rate shaping is not performed, the egress rate may be substantially the same as the ingress rate as illustrated in FIG. 2C. However, when egress rate shaping is performed, an egress rate may be substantially smoother than the ingress rate as illustrated in FIG. 2D. In an embodiment, a target egress rate may be an average of the ingress rate.

Further, without egress rate shaping, a client application may estimate a stable data rate that is substantially lower than the data rate actually provided by a channel as illustrated in FIG. 2E. When egress rate shaping is performed, a client application may estimate a higher data rate that more accurately reflects the data rate that may be provided by the channel as illustrated in FIG. 2F. In an embodiment, the rate shaper may use a rate estimation algorithm in which large bursts of delivered data may be ignored for the purpose of estimating a stable input rate.

As illustrated in FIG. 2G, when egress rate shaping is not performed, the client application may select a playback rate based on ingress rate estimated on by the application (e.g., illustrated in FIG. 2E), which may result in a suboptimal rendering or presentation of the media (e.g., rending at 320 by 240 pixels per inch when the actual data rate will support 640 by 480 pixels per inch). When egress rate shaping is performed, the client application may more accurately estimate the incoming data rate as illustrated in FIG. 2F, and based on this more accurate estimate, select a playback rate consistent with the actually data rate as illustrated in FIG. 2H. Using a more accurate playback rate may enable the client application to present or render the media at a higher quality, such as playing the media at a higher resolution (e.g., 640 by 480 pixels per inch).

Thus, when egress rate shaping is applied to data delivered to the client application, the client application may estimate a higher stable input rate as illustrated by comparing FIG. 2E to FIG. 2F, and as a result the client application may select a higher rendering or playback rate as illustrated by comparing FIG. 2G to FIG. 2H. The client application may therefore render or playback content at a higher quality or resolution when egress rate shaping is performed.

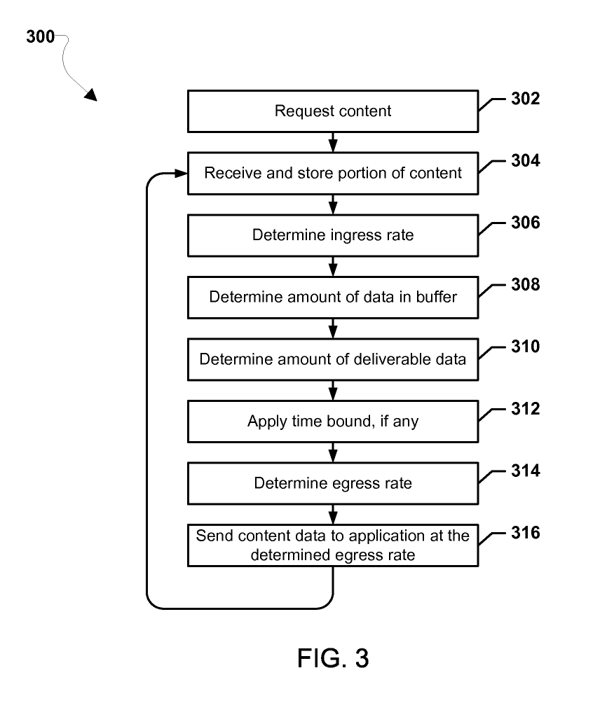

FIG. 3 illustrates a method 300 for rate shaping data delivery to a client application according to various embodiments. The method 300 may be implemented by a processor performing or controlling operations of a rate shaper (e.g., rate shaper/accelerator 102a, 104a, and 106a of FIG. 1), which may be implemented within a wireless device (e.g., by a processor of the wireless device 102 of FIG. 1), within a base station (e.g., by a processor of the base station 104 of FIG. 1), or within an access point (e.g., by a processor of the access point 106 of FIG. 1). In block 302, the wireless device (e.g., the wireless device 102 of FIG. 1) may request the delivery of content data from a server (e.g. the server 110 of FIG. 1). The request for the content data may be, for example, an HTTP request for delivery of the content data using an HTTP protocol, which may include an HTTP streaming protocol. In block 304, a rate shaper (e.g. rate shaper/accelerator 102a, 104a, or 106a of FIG. 1) may receive a portion of the requested content data and buffer the received portion in a memory of the rate shaper. As the rate shaper receives portions (e.g., data packets or chunks) of the requested content, data may arrive out of order, and the rate shaper may store content data in a buffer as it arrives until an entire portion or sequence of the content data has been received.

In order to smooth the rate at which the rate shaper delivers the content data to a client application (e.g., the client application 102b of FIG. 1), the processor may determine an egress rate at which to send content data from the buffer to the client application. For example, in block 306, the processor may determine an ingress rate at which the rate shaper receives the content data. The ingress rate may include the rate (e.g., in bits per second) at which the content data is received by the rate shaper, the rate at which content data is stored in the buffer of the rate shaper, or another data rate. This information may be useful to determining a suitable egress rate because when the ingress rate is higher (or is increasing), the egress rate may be increased, and when the ingress is lower (or is decreasing), the egress rate may be decreased to match, or to be closer to, the ingress rate.

In block 308, the processor may determine an amount of content data stored in the buffer of the rate shaper. This information may be useful to determining a suitable egress rate because a higher egress rate may be acceptable as the amount of content data stored in the buffer increases over time. In some embodiments, a fixed egress rate may be determined based at least in part on an initial buffer length.

In block 310, the processor may determine an amount of deliverable content data stored in the buffer. Deliverable data may include stored data that is in a state in which it may be sent to the client application, such as a sequence of content data packets that are in order or substantially in order. This information may be useful in determining a suitable egress rate because the egress rate may be increased when the amount of deliverable data is higher (or is increasing), and the egress rate may be decreased when the amount of deliverable data is lower (or is decreasing).

In block 312, the processor may apply a time bound. For example, the processor may be configured to clear all buffered data of the rate shaper within a certain period of time (e.g., within one second after received data is buffered). As another example, the processor may be configured to guarantee delivery of buffered bytes from the rate shaper to the client application within a certain time bound. This information may be useful to determining a suitable egress rate because the egress rate may be increased when the time bound is shorter and the egress rate may be decreased when the time bound is longer.

In block 314, the processor may determine an egress rate at which buffered data may be sent from the rate shaper to the client application based on the determined ingress rate, the determined amount of data in the rate shaper buffer, the determined amount of deliverable data, any applied time bound, any other suitable factor, or any combination thereof. In block 316, the rate shaper may send buffered content data to the client application at the determined egress rate.

The method 300 may be repeated in a continuous loop while content data is being received. Thus, the processor may employ the method 300 to dynamically determine an egress rate of data from the rate shaper buffer based on several criteria that may change over time.

Not all of the operations in blocks 306-318 are required, and in some embodiments the method 300 may be performed with any of the blocks 306-312, and in some embodiments any of the blocks 306-312 may be omitted from the method 300. The operations of any or all of the blocks 306-312 may be performed in various orders, and may be performed in series or substantially in parallel (i.e., substantially simultaneously).

In some embodiments, the processor may determine the egress rate as a function of the ingress rate, which may be expressed as R_{E}(n)=kR₁(n), in which R₁(n) is an ingress rate, k is a factor of the ingress rate, and R_{E}(n) is an egress rate. In some embodiments, the processor may determine the egress rate as a function of an amount of data stored in the rate shaper buffer, which may be expressed as R_{E}(n)=B(n)/T, in which B(n) is an amount of data stored in the rate shaper buffer, T is a parameter that represents how quickly the buffer is cleared, and R_{E}(n) is an egress rate. In some embodiments, the processor may determine the egress rate as a function of the ingress rate and the buffer size, which may be expressed as R_{E}(n)=kR₁(n)+B(n)/T.

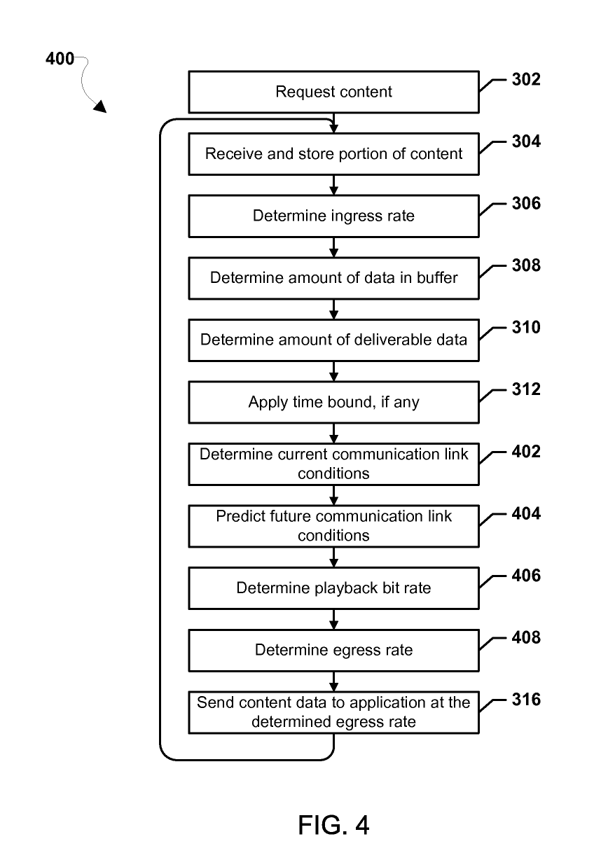

FIG. 4 illustrates a method 400 for rate shaping data delivery to a client application according to various embodiments. The method 400 may be implemented by a processor performing or controlling operations of a rate shaper (e.g., rate shaper/accelerator 102a, 104a, and 106a of FIG. 1), which may be implemented within a wireless device (e.g., by a processor of the wireless device 102 of FIG. 1), within a base station (e.g., by a processor of the base station 104 of FIG. 1), or within an access point (e.g., by a processor of the access point 106 of FIG. 1). In block 302, the wireless device (e.g., the wireless device 102 of FIG. 1) may request the delivery of content data from a server (e.g., the server 110 of FIG. 1), and in block 304, a processor of a rate shaper or rate shaper (e.g. the rate shaper/accelerator 102a, 104a, or 106a of FIG. 1) may receive a portion of the requested content data and buffer the received portion in a memory of the rate shaper. In block 306, the processor may determine an ingress rate at which the rate shaper receives the content data, and in block 308, the processor may determine an amount of content data stored in the buffer. In block 310, the processor may determine an amount of deliverable content data stored in the buffer, and in block 312, the processor may apply a time bound. In some embodiments, the operations performed in blocks 302-312 may be similar to the operations of like number blocks of the method 300 described with reference to FIG. 3.

In block 402, the processor may determine current communication link conditions of the communication link over which the rate shaper is receiving the content data (e.g., wireless communication links 112 and 116 of FIG. 1). The communication link conditions may include a maximum received data rate or throughput of received content data, an average or stable data rate or throughput of received content data, a signal strength measurement (e.g., a reference signal received power (RSRP) or received signal strength indicator (RSSI)), a signal quality measurement (e.g., a reference signal received quality (RSRQ) or channel quality indicator (CQI)), an amount of channel or communication link congestion, and other communication link conditions. For example, when the current communication link conditions are relatively good (or are improving), the egress rate may be increased, and when the communication link conditions are relatively poor (or are deteriorating), the egress rate may be decreased.

In block 404, the processor may determine future communication link conditions. For example, when the rate shaper is implemented in a mobile wireless device, the processor may determine whether the wireless device is moving toward or away from a base station or access point, and anticipate whether communication link conditions are likely to improve or deteriorate based on this determination. This information may be useful in establishing the egress rate because when the processor anticipates that the future communication link conditions may improve, the egress rate may be increased, and when the processor anticipates that the communication link conditions may deteriorate, the egress rate may be decreased.

In block 406, the processor may determine a bit rate, for instance a desired bit rate, for presentation or playback of the content data by the client application. For example, the communication link (based on determined current and/or future communication link conditions) may be capable of supporting a certain bit rate or throughput to the wireless device. The client application may provide a preferred presentation bit rate for the content data based in part on the throughput provided (or supportable) by the communication link. In some embodiments, the processor may monitor the client application to determine possible playback bit rates and/or the preferred playback bit rate, and the processor may be configured to adjust the bit rate of data provided to the client application from the rate shaper accordingly. This information may be useful in establishing the egress rate because when the desired bit rate is relatively high, the egress rate may be increased, and when the desired bit rate is relatively low, the egress rate may be decreased.

In block 408, the processor may determine an egress rate at which buffered data may be sent from the rate shaper to the client application based on the determined ingress rate, the determined amount of data in the rate shaper buffer, the determined amount of deliverable data, any applied time bound, the present and future communication link conditions, the desired bit rate for presentation or playback of the content data, any other suitable factor, or any combination thereof.

In block 316, the rate shaper may send buffered content data to the client application at the determined egress rate. The operations performed in block 316 may be similar to those of block 316 of the method 300 described with reference to FIG. 3.

The method 400 may be repeated in a continuous loop while content data is being received. Thus, the method 400 may dynamically determine an egress rate of data from the rate shaper buffer based on several criteria that may change over time. Not all of the operations in blocks 306-406 are required; in some embodiments the method 400 may be performed with any of the blocks 306-406 and some of the blocks 306-406 may be omitted from the method 400. The operations of any or all of the blocks 306-406 may be performed in various orders, and may be performed in series or substantially in parallel (i.e., substantially simultaneously).

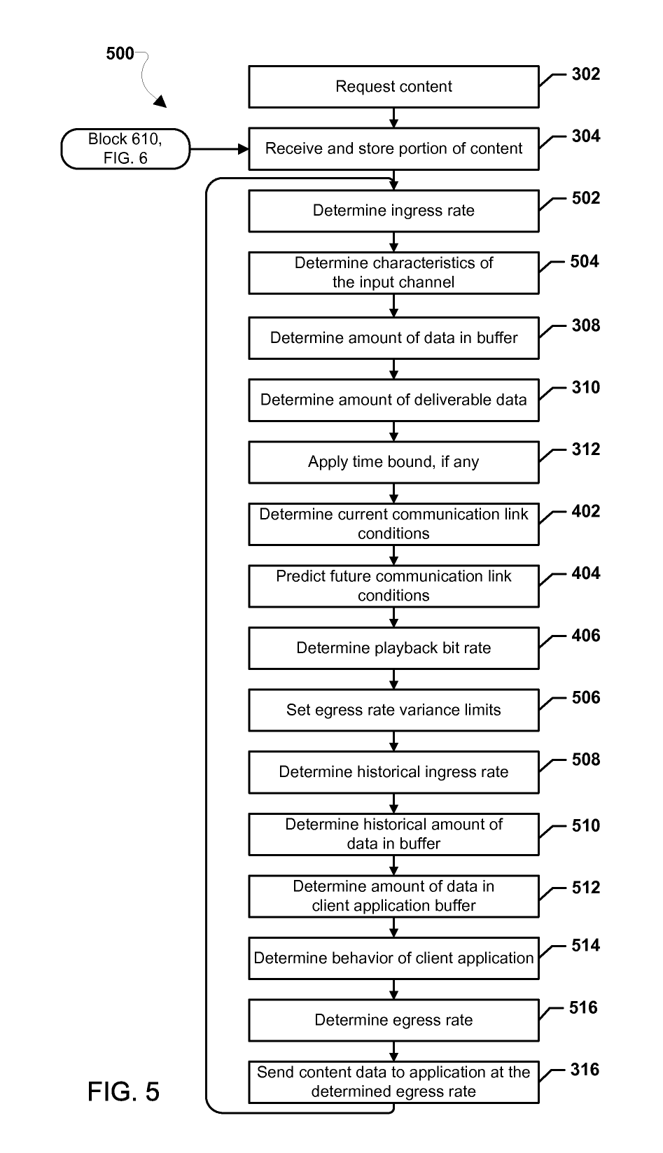

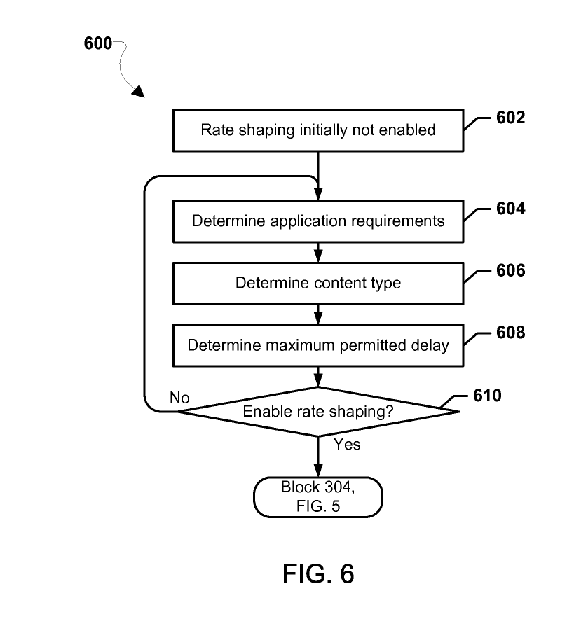

FIG. 5 illustrates a method 500 for rate shaping data delivery to a client application according to various embodiments. The method 500 may be implemented by a processor performing or controlling operations of a rate shaper (e.g., rate shaper/accelerator 102a, 104a, and 106a of FIG. 1), which may be implemented within a wireless device (e.g., by a processor of the wireless device 102 of FIG. 1), within a base station (e.g., by a processor of the base station 104 of FIG. 1), or within an access point (e.g., by a processor of the access point 106 of FIG. 1). In block 302, the wireless device (e.g., the wireless device 102 of FIG. 1) may request the delivery of content data from a server (e.g., the server 110 of FIG. 1), and in block 304, a rate shaper or rate shaper (e.g. rate shaper/accelerator 102a, 104a, or 106a of FIG. 1) may receive a portion of the requested content data and buffer the received portion in a memory of the rate shaper. Based on certain criteria, the processor may determine that it should enable rate shaping, illustrated as an input into block 304 from block 610 as described below with reference to FIG. 6.

In block 502, a processor may determine an ingress rate at which the rate shaper receives the content data. Because ingress rate may not be a constant or steady rate of data receipt, and may vary over time, the determination of the ingress rate in block 502 may characterize the ingress rate using one or more statistical parameters. For example, the determined ingress rate determined in block 502 may be characterized in terms of an average data rate or a median data rate. The determined ingress rate may also be characterized in terms of a statistical analysis of the ingress rate over time. For example, the processor may determine a range of variation in the observed ingress rate. The rate shaper may also determine a distribution of received data rates within the rate variation. The distribution of received data rates may be characterized in terms of a percentile distribution. For example, the processor may determine that the ingress rate varies from 1 Mbps to 6 Mbps within a defined period of time. Continuing this example, the processor may further determine that 1% of the period the ingress rate is 1 Mbps, 2% of the period the ingress rate is 2 Mbps, 2% of the period the ingress rate is 3 Mbps, 3% of the period the ingress rate is 4 Mbps, 90% of the period the data rate is 5 Mbps, and 2% of the period the data rate is 6 Mbps. Other forms of statistical analysis and characterization of the ingress rate are also possible. For example, the processor may determine a mean of the ingress rate and/or a variance of the ingress rate.

In block 504, the processor may determine characteristics of the input channel over which the rate shaper receives the content data from a server (e.g., the content server 110 of FIG. 1). The processor may determine the characteristics of the input channel using information from a network-monitoring module (e.g., the network monitoring module 102c of FIG. 1). Examples of the characteristics of the input channel may include an RTT, a PER, a probability of PER, a joint probability distribution of number of bytes and inter-arrival times, and combinations of any of such metrics. Other input channel characteristics that the processor may determine include a maximum data rate or throughput of received content data, an average or stable data rate or throughput of received content data, a signal strength measurement (e.g., a reference signal received power (RSRP) or received signal strength indicator (RSSI)), a signal quality measurement (e.g., a reference signal received quality (RSRQ) or channel quality indicator (CQI)), an amount of channel or communication link congestion, and other communication link conditions. As another example, the processor may determine MAC layer errors (i.e., data transmission errors), which may include a number, average number, and/or mean number of transmission retries and/or transmission failures. As yet another example, the processor may determine (or estimate) a fraction of communication link resources, such as such as resource elements or resource blocks, which are allocated to the wireless device (e.g., by a processor of a base station or an access point, such as the base station 104 or the access point 106 of FIG. 1). This information may be useful in establishing the egress rate because when the historical communication link conditions are relatively good (or improve), the egress rate may be increased, and when the historical communication link conditions are relatively poor (or deteriorate), the egress rate may be decreased.

In block 308, the processor may determine an amount of content data stored in the buffer. In block 310, the processor may determine an amount of deliverable content data stored in the buffer, and in block 312, the processor may apply a time bound. In some embodiments of the operations performed in blocks 302-312 may be similar to the operations of like numbered blocks of the method 300 described with reference to FIG. 3.

In block 402, the processor may determine current communication link conditions of the communication link over which the wireless device receives the content data. In block 404, the processor may determine future communication link conditions. In block 406, the processor may determine a desired bit rate for presentation or playback of the content data by the client application. In some embodiments of the operations performed in blocks 402-406 may be similar to the operations of like numbered blocks of the method 400 described with reference to FIG. 4.

In block 506, the processor may set egress rate variance limits. For example, the processor may determine that the dynamically determined egress rate may not vary greater than a certain amount per unit time, or that the dynamically determined egress rate may not vary greater than a certain amount from the previously-determined egress rate each time the egress rate is determined.

In block 508, the processor may determine a historical ingress rate. The historical ingress rate may include an amount of content data received by the rate shaper in a period of time, or an amount of content data stored in the buffer in a period of time. The historical ingress rate may include a running average of the amount of content data received and/or buffered over a moving window period of time. This information may be useful in establishing the egress rate because when the historical ingress rate is relatively high, the egress rate may be increased, and when the historical ingress rate is relatively low, the egress rate may be decreased.

In block 510, the processor may determine a historical amount of data in the rate shaper buffer. For example, the processor may determine a variation of the amount of buffered data over time, to determine whether the amount of buffered data tends to grow, shrink, or remain relatively steady, over a period of time. This information may be useful in establishing the egress rate because when the historical amount of data in the buffer is relatively large (or increases), the egress rate may be increased, and when the historical amount of data in the buffer is relatively small (or decreases), the egress rate may be decreased.

In block 512, the processor may determine an amount of content data in a buffer of the client application. In some embodiments, the processor may also compare the determined amount of data in the client application buffer to a buffer threshold. For example, the processor may determine that, for a current playback rate at which the client application may present the content data, the client application buffer stores sufficient content data, or that the client application buffer is running low on content data (either as an absolute value of the amount of content data in the client application buffer, or as compared to a client application buffer threshold) such that the client application may risk stalling or otherwise suffering degraded performance for lack of sufficient buffered content data. This information may be useful in establishing the egress rate because the amount of data in the client application buffer meets or is below the client application buffer threshold, the egress rate may be increased. The processor may also determine a difference between the amount of content data in the client application buffer and the client application buffer threshold, and the processor may use the difference to determine the egress rate. This information may be useful in establishing the egress rate because as the amount of content data in the client application buffer decreases below the buffer threshold (i.e., as the difference below the threshold increases), the egress rate may be increased, and as the amount of content data in the client application buffer increases above the threshold, the egress rate may be decreased.

In block 514, the processor may determine a behavior of the client application. For example, the client application may send requests to the rate shaper for content data from the rate shaper buffer periodically, and the processor may determine a frequency at which the client application sends requests for content data from the rate shaper buffer. As another example, the processor may determine a pattern of requests for content data sent by the client application to the rate shaper, such as a variation in frequency over time. In some embodiments, the processor may determine a statistical analysis of requests for content data sent by the client application to the rate shaper. As another example, the processor may determine a pattern in which the client application reads and/or requests data from the rate shaper buffer, such as a variation in an amount of data and/or a rate of data reading and/or requests.

In block 516, the processor may determine an egress rate at which buffered data may be sent from the rate shaper to the client application based on the ingress rate, the characteristics of the input channel, the amount of data in the rate shaper buffer, the amount of deliverable data, any applied time bound, the present and future communication link conditions, the desired bit rate for presentation or playback of the content data, the egress rate variance limits, the historical ingress rate, the historical amount of data in the rate shaper buffer, the amount of content data in the client application buffer relative to the buffer threshold, the behavior of the client application, any other suitable factor, or any combination thereof.

In some embodiments, the processor may use a determined variation in the ingress rate, such as a statistical analysis of the ingress rate, to determine an egress rate that varies over time. In some embodiments, the processor may shape the egress rate based on the determined variation of the ingress rate in order to provide the client application with content data in a manner that reflects variations in the ingress rate, so that the client application may select an appropriate rendering or playback rate for the content data. For example, the processor may shape the egress rate using a statistical analysis of the ingress rate, such as a determined distribution of received data rates, which may be within a range of ingress rate variations. The processor may also shape the egress rate using a distribution of the ingress data rate, such as a percentile distribution, so that the distribution of the egress rate is based on the distribution of the ingress rate. In some embodiments, the rate shaper may store received content data in the buffer, reorder any content data received out of order, and transmit the reordered content data to the client application using a rate-shaped egress rate based on the determined variation in the ingress rate.

Additionally or alternatively, in some embodiments, the processor may use characteristics of the input channel to shape the egress rate based on the determined input channel characteristics. Shaping the egress rate based on input channel characteristics may provide the client application with content data in a manner that reflects the channel characteristics of the input channel, so that the client application may select an appropriate rendering or playback rate for the content data. For example, the rate shaper may use an RTT, a PER, a probability of PER, and a joint probability distribution of number of bytes and inter-arrival times, a maximum data rate or throughput of received content data, an average or stable data rate or throughput of received content data, a signal strength measurement (e.g., a reference signal received power (RSRP) or received signal strength indicator (RSSI)), a signal quality measurement (e.g., a reference signal received quality (RSRQ) or channel quality indicator (CQI)), an amount of channel or communication link congestion, any other metrics, or combinations of any of the foregoing. In some embodiments, the rate shaper may store received content data in the buffer, reorder any content data received out of order, and transmit the reordered content data to the client application using a rate-shaped egress rate based on the determined variation in the ingress rate.

Additionally or alternatively, in some embodiments, the processor may use the behavior of the client application to shape the egress rate. For example, the processor may use a frequency at which the client application sends request for content data from the rate shaper buffer to shape the egress rate so that the client application may select an appropriate rendering or playback rate for the content data. In some embodiments, the processor may shape the egress rate based on a determined frequency at which the client application sends requests for content data from the rate shaper buffer. In some embodiments, the processor may shape the egress rate based on a determined pattern of requests for content data sent by the client application to the rate shaper, such as a variation in frequency over time. In some embodiments, the processor may shape the egress rate based on a determined statistical analysis of requests for content data sent by the client application to the rate shaper.

In block 316, the rate shaper may send buffered content data to the client application at the determined egress rate. The operations performed in block 316 may be similar to those of block 316 of the method 300 described with reference to FIG. 3.

The method 500 may be repeated in a continuous loop while content data is being received. Thus, the method 500 may dynamically determine an egress rate of data from the rate shaper buffer based on several criteria that may change over time. Not all of the blocks 306-510 are required, and in some embodiments the method 500 may be performed with any of the blocks 306-510, and any of the blocks 306-510 may be omitted from the method 500. The operations of any or all of the blocks 310-510 may be performed in various orders, and may be performed in series or substantially in parallel (i.e., substantially simultaneously).

FIG. 6 illustrates a method 600 for rate shaping data delivery to a client application according to various embodiments. The method 600 may be implemented by a processor performing or controlling operations of a rate shaper (e.g., rate shape/accelerator 102a, 104a, and 106a of FIG. 1), which may be implemented within a wireless device (e.g., by a processor of the wireless device 102 of FIG. 1), within a base station (e.g., by a processor of the base station 104 of FIG. 1), or within an access point (e.g., by a processor of the access point 106 of FIG. 1). In block 602, the processor may not initially perform rate shaping of content data that the rate shaper receives for the client application, in which case the processor may perform operations to determine whether to enable rate shaping of the content data for delivery to the client application.

In block 604, the processor may determine application requirements of the client application. The application requirements may include a desired playback bit rate of the content data for presentation, as well as a minimum data input rate required by the client application. The application requirements may also include a preference of the client application for enabling egress rate shaping. The preference may be based on a type of content (e.g., video, game, multimedia, or other data-intensive content), a source of the content (e.g., a particular host or content provider), or another indication that applying rate shaping may improve client application performance. For example, the client application may specify its preference by sending a message to the rate shaper, such as through an Application Program Interface (API). In some embodiments, the rate shaper may infer the preference based on information in the request for content data sent by the communication device to the content sender, e.g., a string pattern in a Uniform Resource Locator (URL). Examples of such a string pattern include a hostname, a filetype, and/or a keyword such as “video.” Further, the rate shaper may infer the client application preference using information about the client application, such as an application name and/or a version number of the client application.

In block 606, the processor may determine a content type of the received content data. This information may be useful in establishing the egress rate because the processor may apply a higher delivery priority to video or multimedia data than to a sequence of still images, and apply a higher delivery priority to different layers of a layered multimedia stream. For example, the content data may be streamed to the wireless device in layers, including a base layer and an enhancement layer, in which base layer data is fundamental to the presentation of the content data, and enhancement layer data is not required, but may be used to provide a higher resolution playback or a higher bit rate playback of the content data in combination with the base layer data. The processor may apply a higher delivery priority to base layer data than to enhancement layer data.

In block 608, the processor may determine a maximum permitted data delay of content data from the rate shaper to the client application. The maximum permitted data delay may include a minimum throughput, a minimum error rate, and/or a maximum data loss rate.

In determination block 610, based on the application requirements of the client application, the content type of the received content data, the maximum permitted data delay, any other suitable factor, or any combination thereof, the processor may determine whether to enable rate shaping on data sent from the rate shaper to the client application. In response to determining that rate shaping should not be enabled (i.e., determination block 610=“No”), the processor may repeat the operations in block 604 as described. In response to the determining that rate shaping should be enabled (i.e., determination block 610=“Yes”), the processor may perform the operations in block 304 of the method 500 described with reference to FIG. 5. Thus, the processor may dynamically determine whether to enable rate shaping on content data sent from the rate shaper to the client application.

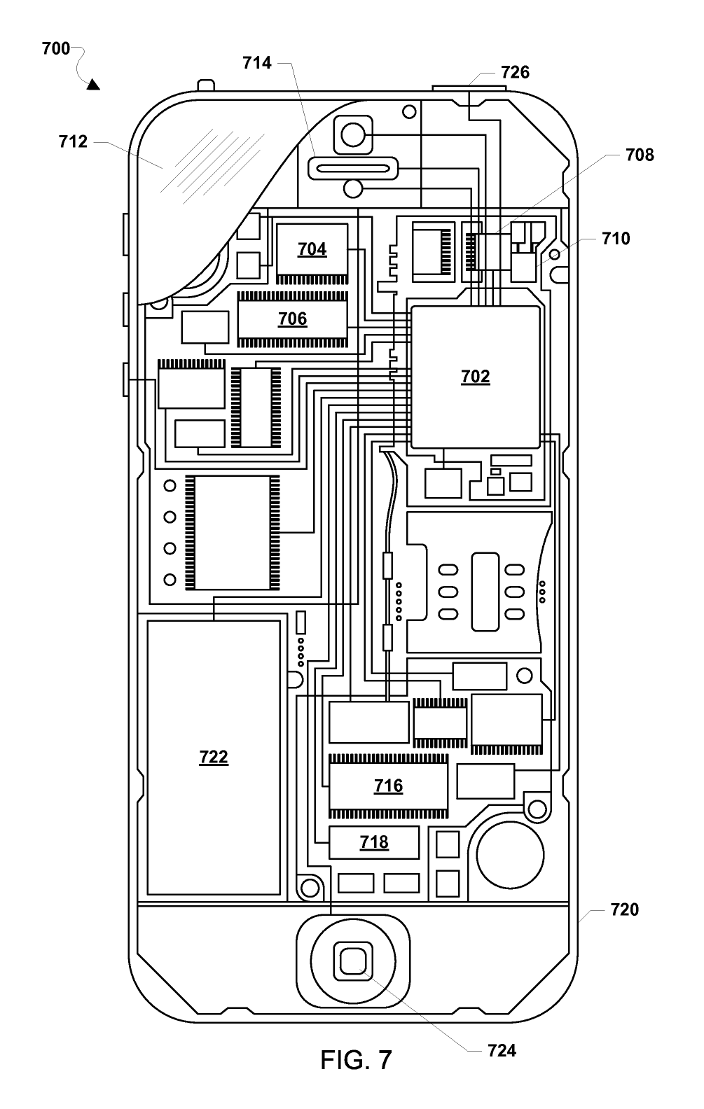

FIG. 7 is a component block diagram of a mobile communication device 700 suitable for implementing various embodiments, for instance, some or all of the methods illustrated in FIGS. 3-6. The mobile communication device 700 may include a processor 706 coupled to a touchscreen controller 704 and an internal memory 702. The processor 706 may be one or more multi-core integrated circuits designated for general or specific processing tasks. The internal memory 702 may be volatile or non-volatile memory, and may also be secure and/or encrypted memory, or unsecure and/or unencrypted memory, or any combination thereof. The touchscreen controller 704 and the processor 706 may also be coupled to a touchscreen panel 712, such as a resistive-sensing touchscreen, capacitive-sensing touchscreen, infrared sensing touchscreen, etc. Additionally, the display of the mobile communication device 700 need not have touch screen capability.

The mobile communication device 700 may have two or more radio signal transceivers 708 (e.g., Peanut, Bluetooth, Zigbee, Wi-Fi, RF radio) and antennae 710, for sending and receiving communications, coupled to each other and/or to the processor 706. The transceivers 708 and antennae 710 may be used with the above-mentioned circuitry to implement the various wireless transmission protocol stacks and interfaces. The mobile communication device 700 may include one or more cellular network wireless modem chip(s) 716 coupled to the processor and antennae 710 that enables communication via two or more cellular networks via two or more radio access technologies.

The mobile communication device 700 may include a peripheral device connection interface 718 coupled to the processor 706. The peripheral device connection interface 718 may be singularly configured to accept one type of connection, or may be configured to accept various types of physical and communication connections, common or proprietary, such as USB, FireWire, Thunderbolt, or PCIe. The peripheral device connection interface 718 may also be coupled to a similarly configured peripheral device connection port (not shown).

The mobile communication device 700 may also include speakers 714 for providing audio outputs. The mobile communication device 700 may also include a housing 720, constructed of a plastic, metal, or a combination of materials, for containing all or some of the components discussed herein. The mobile communication device 700 may include a power source 722 coupled to the processor 706, such as a disposable or rechargeable battery. The rechargeable battery may also be coupled to the peripheral device connection port to receive a charging current from a source external to the mobile communication device 700. The mobile communication device 700 may also include a physical button 724 for receiving user inputs. The mobile communication device 700 may also include a power button 726 for turning the mobile communication device 700 on and off.

The processor 706 may be any programmable microprocessor, microcomputer or multiple processor chip or chips that can be configured by software instructions (applications) to perform a variety of functions, including the functions of various embodiments described below. In some mobile communication devices, multiple processors 706 may be provided, such as one processor dedicated to wireless communication functions and one processor dedicated to running other applications. Typically, software applications may be stored in the internal memory 702 before they are accessed and loaded into the processor 706. The processor 706 may include internal memory sufficient to store the application software instructions.

The foregoing method descriptions, process flow diagrams, and call flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the various embodiments. Various modifications to these embodiments will be readily apparent to those skilled in the art, and the generic principles defined herein may be applied to other embodiments without departing from the spirit or scope of the various embodiments. Thus, the various embodiments are not intended to be limited to the embodiments shown herein but is to be accorded the widest scope consistent with the following claims and the principles and novel features disclosed herein.

What is claimed is:

1. A method for rate shaping data delivery to a client application, comprising:
determining an ingress rate of content data to a buffer;
determining an amount of the content data stored in the buffer;
determining an egress rate of the content data from the buffer to the client application based on the ingress rate and the amount of the content data stored in the buffer; and
sending the content data from the buffer to the client application at the determined egress rate.

2. The method of claim 1, further comprising:
determining an amount of deliverable content data in the buffer; and
determining the egress rate of the content data from the buffer to the client application based on the ingress rate, the amount of the content data stored in the buffer, and the amount of deliverable content data in the buffer.

3. The method of claim 1, further comprising:
determining a time bound for delivery of the content data stored in the buffer to the client application; and
determining the egress rate of the content data from the buffer to the client application based on the ingress rate, the amount of the content data stored in the buffer, and the determined time bound.

4. The method of claim 1, further comprising:
determining current communication link conditions of a communication link over which the buffer receives the content data; and
determining the egress rate of the content data from the buffer to the client application based on the ingress rate, the amount of the content data stored in the buffer, and the current communication link conditions.

5. The method of claim 1, further comprising:
predicting future communication link conditions of a communication link over which the buffer receives the content data; and
determining the egress rate of the content data from the buffer to the client application based on the ingress rate, the amount of the content data stored in the buffer, and the predicted future communication link conditions.

6. The method of claim 1, further comprising:
determining a playback bit rate for presentation of the content data by the client application; and
determining the egress rate of the content data from the buffer to the client application based on the ingress rate, the amount of the content data stored in the buffer, and the playback bit rate.

7. The method of claim 1, further comprising:
determining an egress rate variance limit for the buffer; and
determining the egress rate of the content data from the buffer to the client application based on the ingress rate, the amount of the content data stored in the buffer, and the determined egress rate variance limit.

8. The method of claim 1, further comprising:
determining a historical ingress rate of content data into the buffer; and
determining the egress rate of the content data from the buffer to the client application based on the ingress rate, the amount of the content data stored in the buffer, and the historical ingress rate of content data into the buffer.

9. The method of claim 1, further comprising:
determining a historical amount of data in the buffer; and
determining the egress rate of the content data from the buffer to the client application based on the ingress rate, the amount of the content data stored in the buffer, and the historical amount of data in the buffer.

10. The method of claim 1, further comprising:
determining a historical communication link conditions of a communication link over which the buffer receives the content data; and
determining the egress rate of the content data from the buffer to the client application based on the ingress rate, the amount of the content data stored in the buffer, and the historical communication link conditions.

11. The method of claim 1, further comprising:
determining whether an amount of the content data in a buffer of the client application meets a buffer threshold; and
determining the egress rate of the content data from the buffer to the client application based on the ingress rate, the amount of the content data stored in the buffer, and whether the amount of content data in the buffer of the client application meets the buffer threshold.

12. The method of claim 11, further comprising:
determining a difference between the amount of content data in the buffer of the client application and the buffer threshold; and
determining the egress rate of the content data from the buffer to the client application based on the ingress rate, the amount of the content data stored in the buffer, and the difference between the amount of content data in the buffer of the client application and the buffer threshold.

13. The method of claim 1, wherein determining an egress rate of the content data from the buffer to the client application comprises:
determining a variation of the ingress rate of the content data; and
shaping the egress rate based on the determined variation of the ingress rate.

14. The method of claim 1, wherein determining an egress rate of the content data from the buffer to the client application comprises:
determining characteristics of an input channel of the content data to the buffer; and
shaping the egress rate based on the determined characteristic of the input channel.

15. The method of claim 1, wherein determining an egress rate of the content data from the buffer to the client application comprises:
determining a behavior of the client application; and
shaping the egress rate based on the determined behavior of the client application.

16. The method of claim 1, further comprising:
determining a preference of the client application for enabling rate shaping; and
enabling egress rate shaping based on the determined preference of the client application.

17. The method of claim 16, wherein determining a preference of the client application for enabling rate shaping comprises determining the preference based on a request from the client application for the content data.

18. A computing device, comprising:
a buffer memory; and
a processor coupled to the buffer memory, wherein the processor is configured with processor-executable instruction to execute a client application and to perform operations comprising:
determining an ingress rate of content data to a buffer memory;
determining an amount of the content data stored in the buffer memory;
determining an egress rate of the content data from the buffer memory to the client application based on the ingress rate and the amount of the content data stored in the buffer memory; and
sending the content data from the buffer memory to the client application at the determined egress rate.

19. The computing device of claim 18, further comprising:
determining an amount of deliverable content data in the buffer memory; and
determining the egress rate of the content data from the buffer memory to the client application based on the ingress rate, the amount of the content data stored in the buffer memory, and the amount of deliverable content data in the buffer memory.

20. The computing device of claim 18, further comprising:
determining a time bound for delivery of the content data stored in the buffer memory to the client application; and
determining the egress rate of the content data from the buffer memory to the client application based on the ingress rate, the amount of the content data stored in the buffer memory, and the determined time bound.

21. The computing device of claim 18, further comprising:
determining current communication link conditions of a communication link over which the buffer memory receives the content data; and
determining the egress rate of the content data from the buffer memory to the client application based on the ingress rate, the amount of the content data stored in the buffer memory, and the current communication link conditions.

22. The computing device of claim 18, further comprising:
predicting future communication link conditions of a communication link over which the buffer memory receives the content data; and
determining the egress rate of the content data from the buffer memory to the client application based on the ingress rate, the amount of the content data stored in the buffer memory, and the predicted future communication link conditions.

23. The computing device of claim 18, further comprising:
determining a playback bit rate for presentation of the content data by the client application; and
determining the egress rate of the content data from the buffer memory to the client application based on the ingress rate, the amount of the content data stored in the buffer memory, and the playback bit rate.

24. The computing device of claim 18, further comprising:
determining an egress rate variance limit for the buffer memory; and
determining the egress rate of the content data from the buffer memory to the client application based on the ingress rate, the amount of the content data stored in the buffer memory, and the determined egress rate variance limit.

25. The computing device of claim 18, further comprising:
determining a historical ingress rate of content data into the buffer memory; and
determining the egress rate of the content data from the buffer memory to the client application based on the ingress rate, the amount of the content data stored in the buffer memory, and the historical ingress rate of content data into the buffer memory.

26. The computing device of claim 18, further comprising:
determining a historical amount of data in the buffer memory; and
determining the egress rate of the content data from the buffer memory to the client application based on the ingress rate, the amount of the content data stored in the buffer memory, and the historical amount of data in the buffer memory.

27. The computing device of claim 18, further comprising:
determining a historical communication link conditions of a communication link over which the buffer memory receives the content data; and
determining the egress rate of the content data from the buffer memory to the client application based on the ingress rate, the amount of the content data stored in the buffer memory, and the historical communication link conditions.

28. The computing device of claim 18, further comprising:
determining whether an amount of content data in a buffer memory of the client application meets a buffer memory threshold; and
determining the egress rate of the content data from the buffer memory to the client application based on the ingress rate, the amount of the content data stored in the buffer memory, and whether the amount of content data in the buffer memory of the client application meets the buffer memory threshold.

29. A computing device, comprising:
means for determining an ingress rate of content data to a buffer;
means for determining an amount of the content data stored in the buffer;
means for determining an egress rate of the content data from the buffer to a client application based on the ingress rate and the amount of the content data stored in the buffer; and
means for sending the content data from the buffer to the client application at the determined egress rate.

30. A non-transitory processor-readable medium having stored thereon processor-executable instruction configured to cause a processor to perform operations comprising:
determining an ingress rate of content data to a buffer;
determining an amount of the content data stored in the buffer;
determining an egress rate of the content data from the buffer to the client application based on the ingress rate and the amount of the content data stored in the buffer; and
sending the content data from the buffer to the client application at the determined egress rate.
